(19) United States
(12) Patent Application Publication
(10) Pub. No.: US 2001/0054179 A1
(43) Pub. Date: Dec. 20, 2001

(54) Broadcast program receiving apparatus and control method thereof

(76) Inventors: Koichi Nakamura, Gyoda-shi (JP); Yuko Yamazaki, Fukaya-shi (JP)

Correspondence Address: Pillsbury Madison & Sutro, LLP, Ninth Floor, East Tower, 1100 New York Avenue, N.W., Washington, DC, 20005-3918, US

(21) Appl. No.: 09/797,980

(22) Filed: Mar. 5, 2001

(30) Foreign Application Priority Data
May 31, 2000 (JP) 2000-162094

(51) Int. Cl. H04N 7/16; H04N 7/025; H04N 7/10

(52) U.S. Cl. 725/28; 725/25; 725/34

(57) ABSTRACT

The present invention detects that a viewed broadcast program becomes unviewable due to a viewing restriction and automatically selects another predefined viewable broadcast program. The present invention also uses the same screen to display a message notifying that a viewed broadcast program becomes unviewable due to a viewing restriction and a selected viewable broadcast program.

### CROSS-REFERENCE TO RELATED APPLICATIONS

This application is based upon and claims the benefit of priority from the prior Japanese Patent Application No. 2000-162094, filed May 31, 2000, the entire contents of which are incorporated herein by reference.

### BACKGROUND OF THE INVENTION

The present invention relates to a broadcast program receiving apparatus and a control method thereof for receiving and viewing broadcast programs, say, in a digital television broadcasting system.

It is widely known that, in recent years, a digital television broadcasting system using a broadcasting or communication satellite has been put into practical use. This digital television broadcasting system broadcasts by providing a program with rate information for viewing restriction. When the rate information practically exceeds an audience-defined rate at the receiving side, the system uses a viewing restriction capability to control that program to make it unviewable.

For example, a program A is viewed as shown in FIG. 1A and is provided with rate information indicating a violence degree. It is assumed that the rate information becomes 7 and exceeds rate 4 preassigned to a receiver by an audience. In such a case, a screen display for the program A is changed as shown in FIG. 1B. Instead, the screen displays a message notifying that the program A becomes unviewable due to a viewing restriction. In addition, the sound is muted.

When the viewing restriction makes the program unviewable, the audience needs to find other viewable programs. At this time, the audience is necessitated to do cumbersome operations such as selecting programs until an appropriate one is found by watching on the screen or selecting programs by confirming program information on a magazine or newspaper, and the like.

### BRIEF SUMMARY OF THE INVENTION

The present invention has been made in consideration of the foregoing. It is therefore an object of the present invention to provide a broadcast program receiving apparatus and a control method thereof for facilitating program selections by audiences and improving convenience and usefulness for audiences by automatically selecting and displaying other viewable broadcast programs when a program becomes unviewable due to a viewing restriction and the like.

The broadcast program receiving apparatus according to the present invention comprises a detector and a controller. The detector detects that a currently viewed broadcast program becomes unviewable due to a viewing restriction. Based on a detection result of the detector, the controller automatically selects and displays other viewable broadcast programs.

Further, the broadcast program receiving apparatus according to the present invention comprises a detector and a controller. The detector detects that a currently viewed broadcast program provides a scramble screen for charged broadcasting or a quiescent screen after completion of the broadcast. Based on a detection result of the detector, the controller automatically selects and displays other viewable broadcast programs.

A method of controlling the broadcast program receiving apparatus according to the present invention controls this apparatus in order to make a received broadcast program viewable. The control method comprises a detection step of detecting that a currently viewed broadcast program becomes unviewable due to a viewing restriction; and a control step of automatically selecting and displaying other viewable broadcast programs based on a detection result of the detection step.

A method of controlling the broadcast program receiving apparatus according to the present invention controls this apparatus in order to make a received broadcast program viewable. The control method comprises a detection step of detecting that a currently viewed broadcast program provides a scramble screen for charged broadcasting or a quiescent screen after completion of the broadcast; and a control step of automatically selecting and displaying other viewable broadcast programs based on a detection result of the detection step.

If a currently viewed broadcast program becomes unviewable, the above-mentioned configuration and method enable to automatically select and display other viewable broadcast programs. Accordingly, it is possible to facilitate program selections by audiences and improve convenience and usefulness for audiences.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIGS. 1A and 1B illustrate display screens for a viewing restriction function;

FIGS. 2A and 2B illustrate display screens according to an embodiment of the present invention;

FIG. 3 is a block diagram showing an apparatus for implementing a display feature of the embodiment;

FIG. 4 is a block diagram showing in detail apparatus sections of the embodiment;

FIG. 5 shows a flowchart explaining a sequence of operations for the embodiment;

FIGS. 6A and 6B illustrate a first modification of the embodiment;

FIGS. 7A and 7B illustrate a second modification of the embodiment; and

FIGS. 8A and 8B illustrate a third modification of the embodiment.

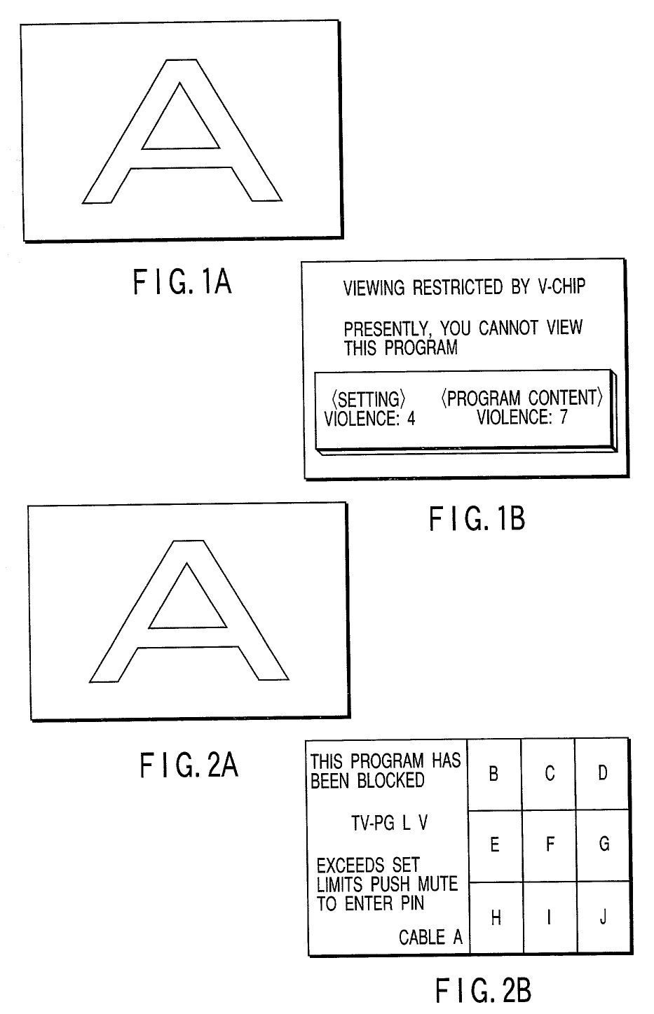

### DETAILED DESCRIPTION OF THE INVENTION

Embodiments of the present invention will be described in further detail with reference to the accompanying drawings. FIGS. 2A and 2B illustrate display screens of a broadcast program receiving apparatus described in this embodiment.

As shown in FIG. 2A, it is assumed that, when an audience views program A, it becomes unviewable due to a viewing restriction. In this case, as shown in FIG. 2B, the broadcast program receiving apparatus horizontally splits the display screen at the center into right and left areas and displays a message for the audience on the left area.

The message contains the following. Text “THIS PROGRAM HAS BEEN BLOCKED” indicates that the program becomes unviewable due to a viewing restriction. “CABLE A” is the name of a program which becomes unviewable. A symbol “TV-PG” indicates the corresponding rate. “LV” is an item name for the rate. Text “EXCEEDS SET LIMITS PUSH MUTE TO ENTER PIN” indicates a method of shifting from the unviewable state to another.

The broadcast program receiving apparatus displays nine viewable programs B to J on the right area of the display screen using a multi-screen display. An audience can easily choose from nine programs B to J on the multi-screen display.

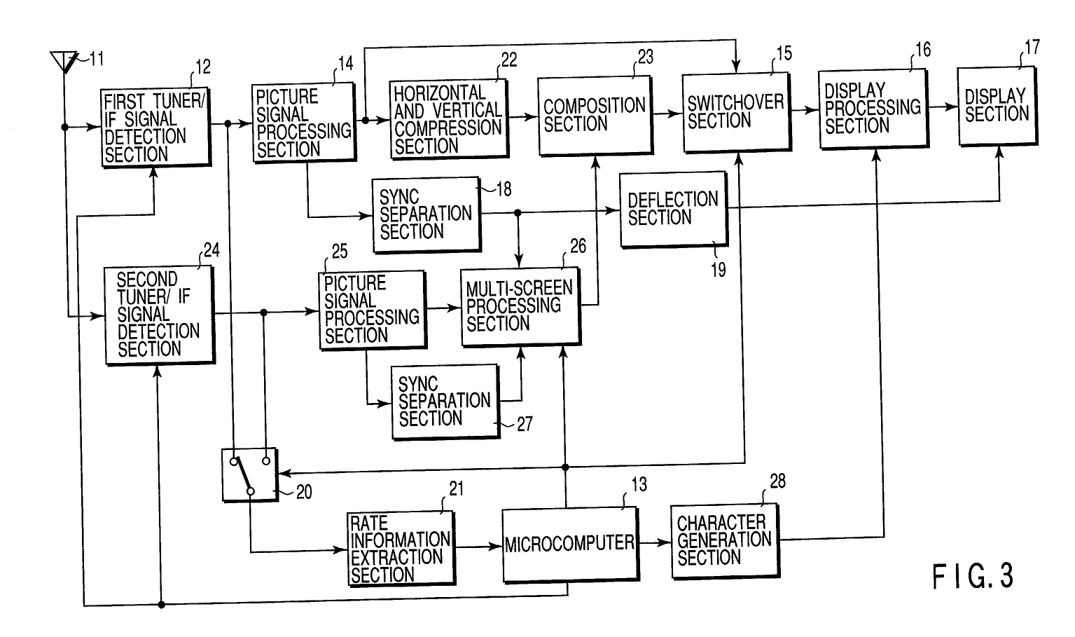

FIG. 3 diagrams a broadcast program receiving apparatus described in this embodiment for implementing the above-mentioned display feature. A picture signal received at an antenna 11 is supplied to a first tuner/IF (Intermediate Frequency) signal detection section 12 for program selection and demodulation. It is assumed that the first tuner/IF signal detection section 12 selects, say, the program A under control of a microcomputer 13 which accepts audience's program operation information.

The picture signal output from the first tuner/IF signal detection section 12 is supplied to a picture signal processing section 14 for treatment by specified picture signal processing. The picture signal is supplied to a switchover section 15, then to a display processing section 16 for screen display processing, and then to a display section 17 for screen display. At this time, a sync separation section 18 separates a synchronizing signal from an output of the picture signal processing section 14. This synchronizing signal is used for control of the display section 17 via a deflection section 19.

An output signal from the first tuner/IF signal detection section 12 is supplied to a rate information extraction section 21 via a switch 20. At this time, rate information attached is extracted from the supplied signal. The switch 20 is controlled by a microcomputer 13. The extracted rate information is compared with a rate which is supplied to the microcomputer 13 and is predefined by an audience.

When the rate information extracted by the rate information extraction section 21 practically does not exceed the predefined rate, the microcomputer 13 controls the switchover section 15 so that an output from the picture signal processing section 14 is supplied to the display processing section 16 as is. Here, normal viewing for the program A takes place.

A picture signal output from picture signal processing section 14 is supplied to a horizontal and vertical compression section 22. As shown in FIG. 2B, the display screen of the display section 17 is horizontally split at the center into right and left areas. The supplied picture signal is compressed so that it fits in the left area of the display screen. The signal is then supplied to the switchover section 15 via a composition section 23.

The picture signal received at the antenna 11 is supplied to a second tuner/IF signal detection section 24 for program selection and demodulation. The second tuner/IF signal detection section 24 sequentially selects programs B to J under control of the microcomputer 13 based on nine program selection information items predefined by an audience.

The rate information is attached to the program A's picture signal output from the first tuner/IF signal detection section 12. When this rate information practically exceeds an audience-defined rate, the second tuner/IF signal detection section 24 first selects and demodulates a picture signal for program B. This picture signal is supplied to a picture signal processing section 25 for specified picture signal processing, and then to a multi-screen processing section 26. The multi-screen processing section 26 compresses and stores the input picture signal so that it can fit to one of nine subdivided areas in the right area of the display section 16's display screen as shown in FIG. 2B. As mentioned above, this display screen is split at the center into right and left areas.

The second tuner/IF signal detection section 24 then selects and demodulates a picture signal for program C. This picture signal is supplied to the picture signal processing section 25 for specified picture signal processing. The multi-screen processing section 26 then compresses and stores the input picture signal so that it can fit to one of nine subdivided areas in the right area of the display section 16's display screen.

Subsequently, a similar operation is used to sequentially select picture signals for programs D to J and create a 9-division multi-screen in the multi-screen processing section 26. After selecting all the programs B to J, the microcomputer 13 controls the second tuner/IF signal detection section 24 to reselect the program B. Thereafter, the programs B to J are circularly selected to update the multi-screen.

In this case, the multi-screen processing section 26 forms the programs B to J into the multi-screen based on a synchronizing signal separated by the sync separation section 27 from a picture signal processing section 25's output.

A signal for the thus created multi-screen is read into the composition section 23 based on the synchronizing signal output from the sync separation section 18. That signal is composed with the picture signal compressed in the horizontal and vertical compression section 22 and is output to the switchover section 15.

The microcomputer 13 controls the second tuner/IF signal detection section 24 to select the picture signal for each of the programs B to J. At this time, the microcomputer 13 controls the switch 20 to supply the picture signal to the rate information extraction section 21 for comparing the associated rate information with an audience-predefined rate.

For example, the rate information attached to the program F's picture signal may practically exceed the audience-defined rate. In this case, the microcomputer 13 blocks a picture display on the sub-area for displaying the program F in the multi-screen. Alternatively, the microcomputer 13 selects an audience-predefined program K to add it to the multi-screen.

The microcomputer 13 then controls the switchover section 15 so that an output from the composition section 23 is supplied to the display processing section 16. Concurrently, the microcomputer 13 issues message information to the display processing section 16 to indicate that the program becomes unviewable due to the viewing restriction predefined in a character generation section 28.

The display processing section 16 processes signals to display the above-mentioned message text on the left area and the multi-screen on the right area of the horizontally spit display screen of the display section 17 as shown in FIG. 2B.

Consequently, the audience can confirm that the selected program A becomes unviewable due to the viewing restriction and can use the multi-screen to easily select the other viewable programs for viewing.

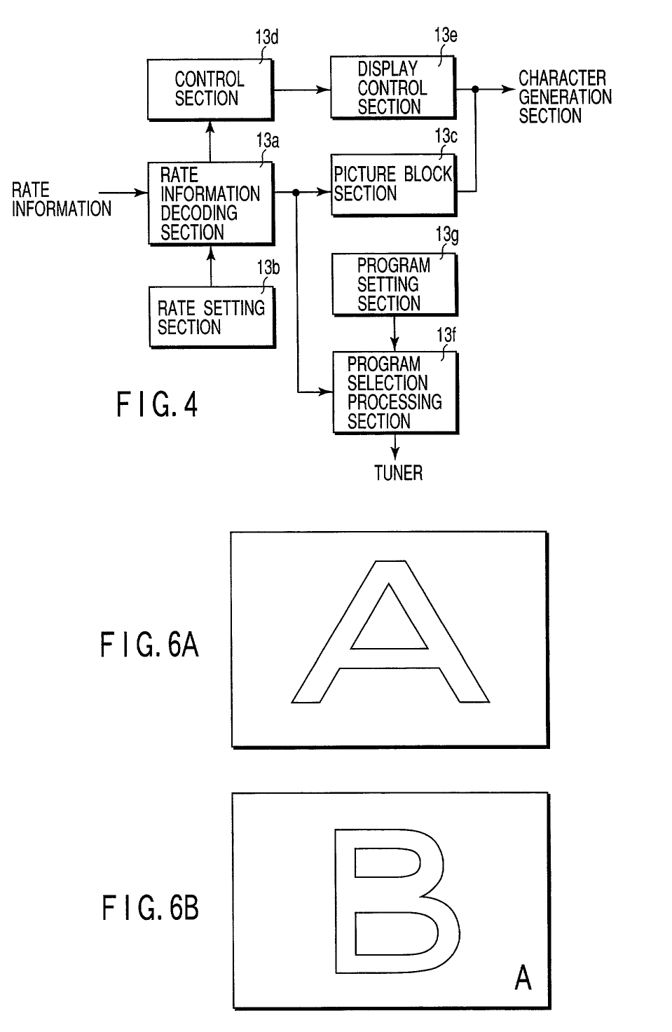

FIG. 4 is a block diagram schematically showing how the microcomputer 13 compares rates. Namely, the rate information extracted in the rate information extraction section 21 is decoded in a rate information decoding section 13a and is compared with a rate stored in a rate setting section 13b which stores rates predefined by audience's operations.

When it is determined that the rate information practically exceeds the audience-defined rate, the rate information decoding section 13a controls a picture block section 13c to block a picture display of the currently selected program. A message from the character generation section 28 is displayed on the blocked screen.

A control section 13d may extract the compared rate information and the corresponding item from the rate information decoding section 13a. In this case, the rate information and the corresponding item are output to the character generation section 28 via a display control section 13e. Accordingly, the character generation section 28 can provide a message content with the rate information (TV-PG) and the corresponding item (LV) as shown in FIG. 2B.

The rate information decoding section 13a drives a program selection processing section 13f when it is determined that the rate information practically exceeds the audience-defined rate. The program selection processing section 13f controls the second tuner/IF signal detection section 24 to sequentially select programs based on program information stored in a program setting section 13g which stores program information previously selected by audience's operations.

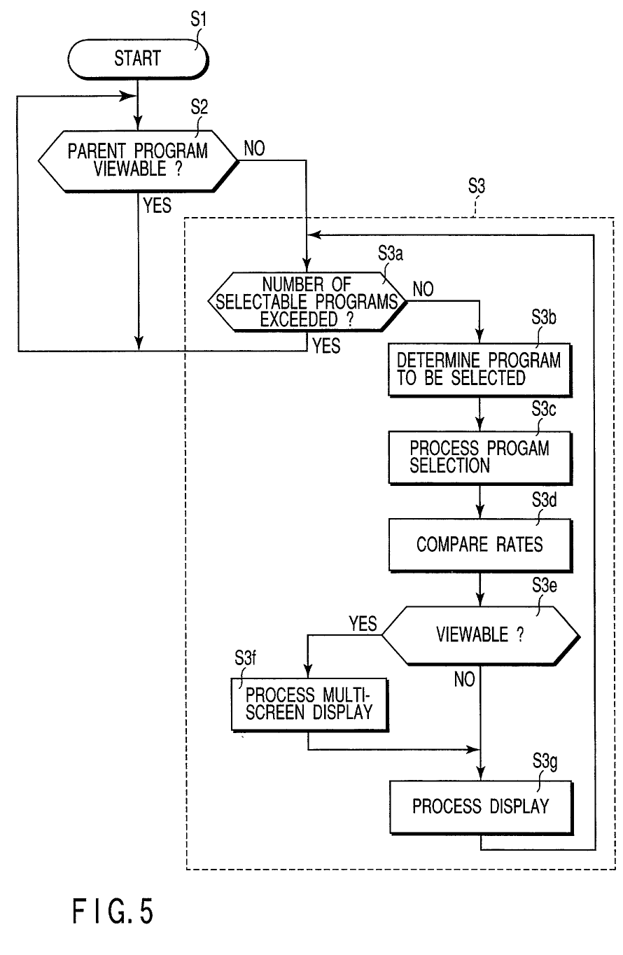

FIG. 5 shows a flowchart explaining a sequence of operations for selecting another viewable program when the current program becomes unviewable due to a viewing restriction. After startup (step S1), the microcomputer 13 checks if the currently selected program (“parent program” in FIG. 5) is viewable at step S2. If it is unviewable (“NO”), program selection processing is performed (step S3).

This program selection processing checks if the number of selectable programs is exceeded at step S3a. If this number is exceeded (“YES”), control returns to step S2.

If the number of selectable programs is not exceeded (“NO”) at step S3a, the process determines a program to be selected according to information stored in the program setting section 13g at step S3b. At step S3c, the second tuner/IF signal detection section 24 is activated to perform program selection processing.

At step S3d, the rate information attached to the selected program is compared with the audience-predefined rate. At step S3e, it is determined whether the program is viewable or not. When the program is viewable (“YES”), processing corresponding to the multi-screen display is applied to the program's picture signal at step S3f. The display processing is performed at step S3g. Control then returns to step S3a.

When the currently viewed program becomes unviewable due to a viewing restriction, the above-mentioned embodiment displays a descriptive message on the screen and automatically displays a plurality of other viewable programs on the multi-screen. Accordingly, it is possible to facilitate program selections by audiences and improve convenience and usefulness for audiences.

Even if the program A is unviewable due to a viewing restriction, the microcomputer 13 keeps selecting the program A and continues monitoring the rate information unless the audience selects the other programs. When the rate information becomes smaller than or equal to the audience-predefined value, the microcomputer automatically redisplays the program A.

FIGS. 6A and 6B illustrate a first modification of the above embodiment. When the program A is viewed as shown in FIG. 6A, it may become unviewable due to a viewing restriction. In such a case, an audience-predefined program B is automatically selected and displayed as shown in FIG. 6B. In this case, the original program number A is displayed at a bottom right corner of the screen displaying the program B, notifying the audience that the program A becomes unviewable and the program B is automatically selected.

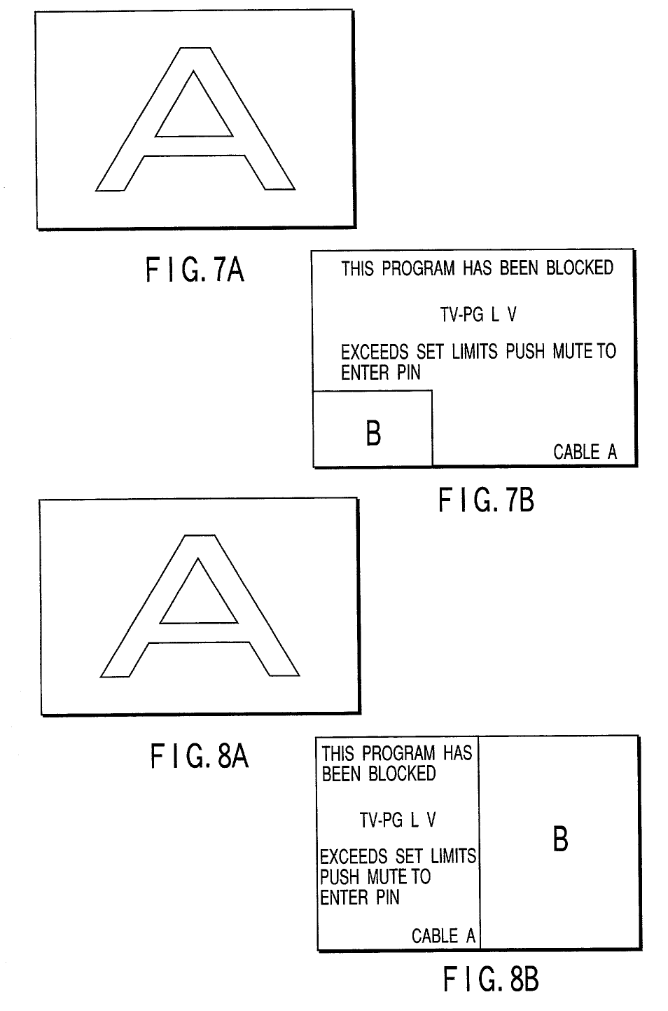

FIGS. 7A and 7B illustrate a second modification of the above embodiment. When the program A is viewed as shown in FIG. 7A, it may become unviewable due to a viewing restriction. In such a case, the full screen displays a message notifying that the program A becomes unviewable. In addition, a PIP (Picture In Picture) function is used to select an audience-predefined program B is selected and is displayed in a child screen.

FIGS. 8A and 8B illustrate a third modification of the above embodiment. When the program A is viewed as shown in FIG. 8A, it may become unviewable due to a viewing restriction. In such a case, the POP (Picture Out Picture) function is used to concurrently display a message screen notifying the program A being unviewable on one divided area and the audience-predefined program B on the other by dividing the screen into two areas.

The above-mentioned embodiment and its modifications have explained the case where the current program becomes unviewable due to a viewing restriction, namely when the currently viewed program's rate information practically exceeds the audience-defined rate. The present invention is not limited thereto. The present invention can be used to automatically select other viewable programs, for example, when a viewed program becomes charged but is not subscribed yet, when a program for a given day ends and becomes unviewable, and the like.

In these case, it may be preferable to automatically select other viewable programs by detecting activation of a scramble picture screen or a quiescent screen.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A broadcast program receiving apparatus comprising:
detector for detecting that a viewed broadcast program becomes unviewable due to a viewing restriction; and
controller for automatically displaying other viewable broadcast programs based on a detection result of the detector.

2. The broadcast program receiving apparatus according to claim 1, wherein said controller uses the same screen to display a message notifying that a viewed broadcast program becomes unviewable due to a viewing restriction.

3. The broadcast program receiving apparatus according to claim 1, wherein said controller displays a plurality of viewable broadcast programs on a multi-screen.

4. The broadcast program receiving apparatus according to claim 1, wherein said controller automatically displays an audience-predefined broadcast program.

5. The broadcast program receiving apparatus according to claim 1, wherein said detector detects that a broadcast program becomes unviewable based on a result of comparing rate information attached to the broadcast program with an audience-defined rate.

6. A broadcast program receiving apparatus comprising:
detector for detecting that a viewed broadcast program becomes a scramble screen for charged broadcasting or a quiescent screen after completion of broadcasting; and
controller for automatically selecting and displaying other viewable broadcast programs based on a detection result of the detector.

7. The broadcast program receiving apparatus according to claim 6, wherein said controller uses the same screen to display a message notifying that a viewed broadcast program becomes unviewable and a selected viewable broadcast program.

8. The broadcast program receiving apparatus according to claim 6, wherein said controller selects a plurality of viewable broadcast programs and displays said plurality of selected broadcast programs on a multi-screen.

9. The broadcast program receiving apparatus according to claim 6, wherein said controller automatically selects and displays an audience-predefined broadcast program.

10. A method of controlling a broadcast program receiving apparatus for making a received broadcast program viewable, comprising:
a detection step for detecting that a viewed broadcast program becomes unviewable due to a viewing restriction; and
a control step for automatically selecting and displaying other viewable broadcast programs based on a detection result of the detection step.

11. The method of controlling a broadcast program receiving apparatus according to claim 10, wherein said control step uses the same screen to display a message notifying that a viewed broadcast program becomes unviewable due to a viewing restriction and a selected viewable broadcast program.

12. The method of controlling a broadcast program receiving apparatus according to claim 10, wherein said control step selects a plurality of viewable broadcast programs and displays said plurality of selected broadcast programs on a multi-screen.

13. The method of controlling a broadcast program receiving apparatus according to claim 10, wherein said control step automatically selects and displays an audience-predefined broadcast program.

14. The method of controlling a broadcast program receiving apparatus according to claim 10, wherein said detection step detects that a broadcast program becomes unviewable based on a result of comparing rate information attached to the broadcast program with an audience-defined rate.

15. A method of controlling a broadcast program receiving apparatus for making a received broadcast program viewable, comprising:
a detection step for detecting that a viewed broadcast program becomes a scramble screen for charged broadcasting or a quiescent screen after completion of broadcasting; and
a control step for automatically selecting and displaying other viewable broadcast programs based on a detection result of the detection step.

16. The method of controlling a broadcast program receiving apparatus according to claim 15, wherein said control step uses the same screen to display a message notifying that a viewed broadcast program becomes unviewable and a selected viewable broadcast program.

17. The method of controlling a broadcast program receiving apparatus according to claim 15, wherein said control step selects a plurality of viewable broadcast programs and displays said plurality of selected broadcast programs on a multi-screen.

18. The method of controlling a broadcast program receiving apparatus according to claim 15, wherein said control step automatically selects and displays an audience-predefined broadcast program.
